(19) United States
(12) Patent Application Publication
(10) Pub. No.: US 2006/0073459 A1
(43) Pub. Date: Apr. 6, 2006

(54) Self-contained doppler effect demonstration

(76) Inventor: Allan Robert Crowe, Batavia, NY (US)

Correspondence Address: ALLAN R. CROWE, 38 BURKE DR, BATAVIA, NY, 14020, US

(21) Appl. No.: 10/957,916

(22) Filed: Oct. 4, 2004

(51) Int. Cl. G09B 23/06

(52) U.S. Cl. 434/300

(57) ABSTRACT

A self-contained Doppler demonstration comprised of an enclosure (20) with a tether attachment site (4). The enclosure (20) contains an electrical power source (12), a power source connector (13), a switch (8), and an auditory tone generator (11).

In operation, the switch (8) is closed, and the demonstrator is rotated on a tether to produce the observed change in auditory pitch/frequency that is the Doppler effect.

### BACKGROUND—FIELD OF INVENTION

This invention provides physics instructors with an improved device for demonstrating the Doppler effect.

### BACKGROUND—DESCRIPTION OF PRIOR ART

There have been three prior approaches to demonstrating the Doppler Effect in the classroom. The various major science supply companies each offer demonstrations based on one of these approaches. None of the demonstrations are patented. (Copies of the science supply catalog listings are appended). The most complex system offered by the conglomerate that includes Welch Scientific uses a motor-driven rotator with a Doppler Whistle mounted on the rotator. The Doppler Whistle contains a reed. The reed vibrates when the teacher blows into a swivel-mounted hose located on the top of the whistle. This system is no longer offered but is still in use by schools.

There are several problems with this approach. It is very expensive, costing several hundred dollars which is a problem for most science departments. The system requires assembly and cleaning of the mouthpiece before use. In active classrooms, the parts can be hard to find when needed. In operating the system, teachers must continuously blow into the whistle and can not speak during the demonstration. Not being able to speak eliminates the teacher's ability to discuss the event while it is occurring.

Welch and its partners now offer a battery-operated version of the device. This device (appendix page 1) has surface-mounted circuitry and battery. This is easily damaged due to its frail wiring and exposed position. The system is so costly as to be unattractive to schools. In operation it is hard to maintain at a steady speed.

The remaining two approaches use battery-powered sound generators. The first of these is offered by Welch and its partners (appendix page 1) and is used in place of the breath-powered whistle and attaches to the motor-driven rotator. While the teacher is able to speak during use, this advantage is off-set by the frail nature of the sound generator and the exposed position of a 9V transistor battery used for power. At high rates of rotation, large centripetal forces create the possibility that the battery may detach, and become a projectile, causing injury.

The science supply company, Science Kit, has used a 9V battery-powered sound-generator which is attached to a tether and swung in a circle (appendix page 2). This Doppler demonstrator has no on-off switch and the 9V battery must be connected and disconnected to operate the demonstrator. Because the demonstrator must be assembled at the time of use and disassembled to end its use, the lesson is interrupted twice before the meaning of the demonstration can be communicated to students. There is no enclosure for this demonstrator and the exposed components are subject to damage in use and storage. Because components are exposed, the demonstrator is also susceptible to student mishandling and damage. The greatest flaw in this demonstrator is the method of tether attachment. The components of the device are mounted on a small piece of wood, and a screw-eye is installed in the end of the board. The end-grain of any piece of wood is the weakest place to install a fastener. The possibility of failure of this connection, whether in end-grain or side-grain, is not small and increases exponentially with the rate of rotation. Science Kit is replacing this demonstrator with my invention described in this application.

The previous two approaches produce the Doppler Effect once with each revolution, allowing a series of events that can be observed as long as the demonstrators are kept in motion.

The third approach is offered by PASCO Scientific (appendix page 3). This Doppler demonstrator slides along a line. It is self-contained and easy to use. Two people are needed to operate the demonstrator, one at each end of the line. While easy to use there is a severe problem with the presentation. In a linear system, the Doppler Effect occurs only once during the motion along the line. The demonstrator's change in frequency can be heard only if the demonstrator passes an observer at high speed. Observers near the starting-point and ending-point of the line will not hear the Doppler Effect. This is because the auditory form of the Doppler effect is based on the difference in frequency between an approaching sound source and a departing sound source. Using the PASCO system, only observers in the middle of the line's path will hear the effect of an approaching and departing sound source. All of the systems are difficult to repair in the case of malfunction.

### OBJECTS AND ADVANTAGES

Accordingly, besides the objects and advantages of the Doppler effect demonstrators described above, several objects and advantages of the self-contained Doppler demonstration are:

a) no assembly is required for use;

b) the self-contained construction reduces the possibility of lost parts and vandalism;

c) integral on-off switch provides for ease of use.

d) In case of malfunction, components can be easily replaced.

Further objects and advantages include a classroom lesson that is not interrupted by set-up and take-down time. The demonstrator is the most economical one available because of the simple construction and few parts. The demonstrator is easily repairable using readily available parts. Placing the demonstrator on a cart on a long incline allows the demonstrator to be used in a linear manner if the instructor desires.

### DESCRIPTION OF INVENTION

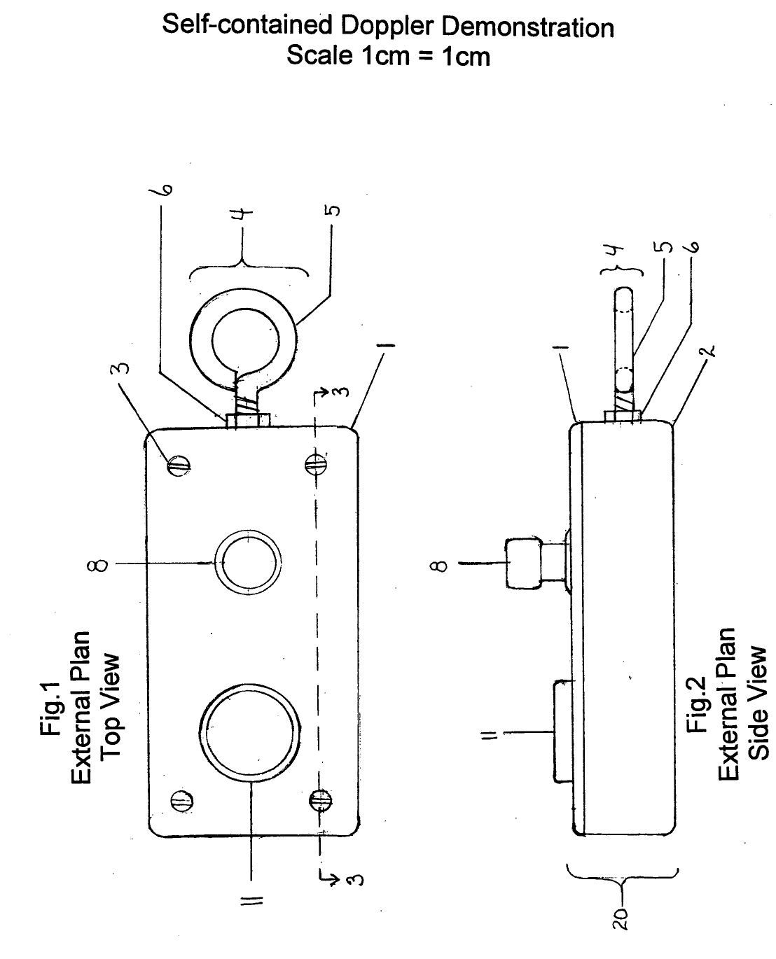

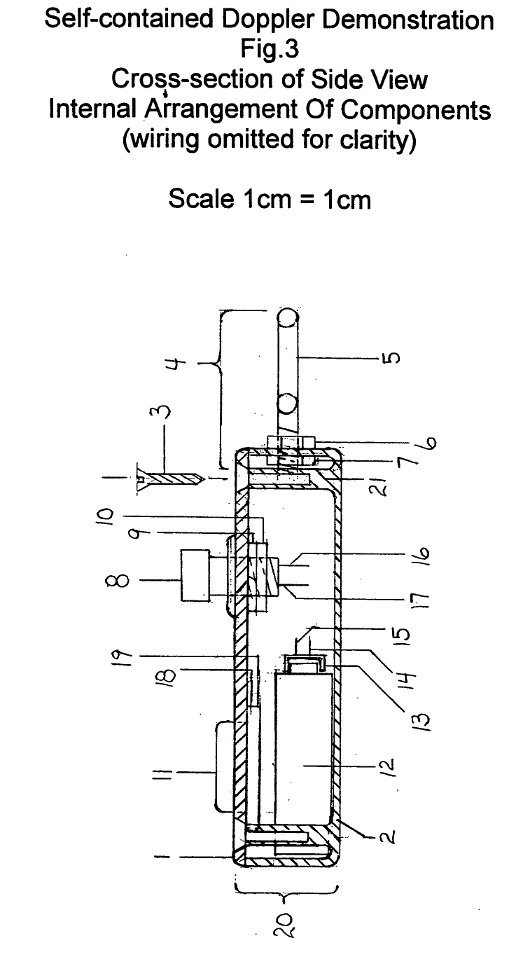

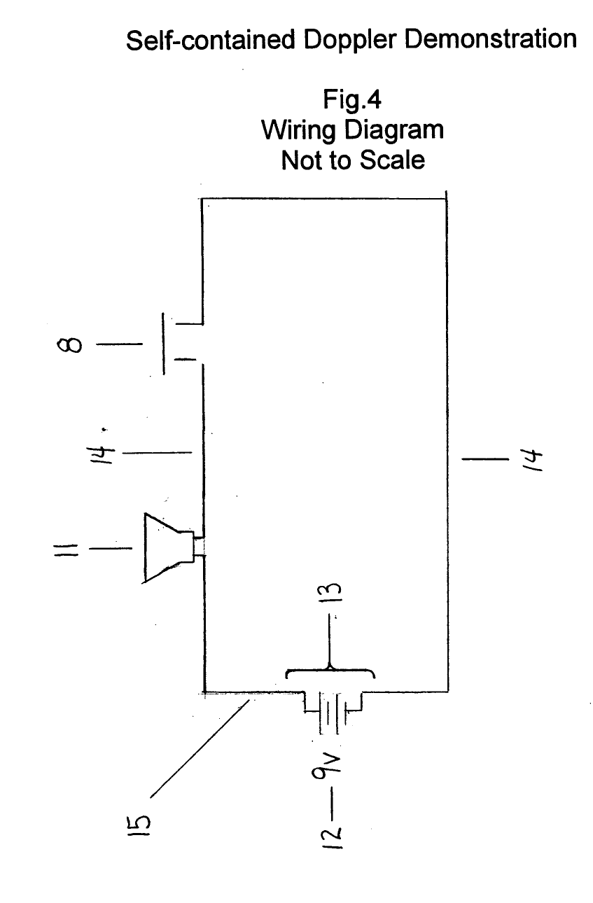

FIGS. 1 and 2 show external top and side views of the Doppler demonstrator. FIG. 3 shows a cross-sectional view of the internal arrangement of components. FIG. 4 is a wiring diagram.

The demonstrator consists of an enclosure (20), 10 cm×5 cm×2.5 cm in size, made of a molded one-piece plastic top cover (1) and a one-piece plastic molding including the bottom and sides (2). The top cover (1) is secured to the bottom and side molding (2) with a screw (3) in each corner of the enclosure which enters an integrally molded screw-post in each corner (21). A 6 mm hole in one end of the bottom and side molding (2) accepts a tether attachment site (4). The tether attachment point consists of a 6 mm diameter, 10 cm long eye-bolt (5) secured to said enclosure with an external nut (6) and internal nut (7).

The top cover (1) has a hole sized to accept a switch (8). The switch (8) is 12.5 mm in diameter, 4 cm in total height and is located on the centerline of the enclosure 3.3 cm from the tether attachment point end and projecting 1.8 cm above the top cover (1). The switch (8) is installed in the hole and secured with lock washer (9) and nut (10).

The top cover (1) has a hole, sized to accept a 24.5 mm diameter, 5 mm high auditory tone generator (11) located on the enclosure's (20) centerline, 8.8 cm from the enclosure's attachment site (4). The tone generator (11) is secured to the enclosure's top (1) on the underside of the enclosure's top (1) with cyanoacrylate glue. The 9V electrical power source (12) is attached to the power source connector (13).

FIG. 4 shows the electrical schematic diagram.

The negative wire (14) from the power source connector (13) connects to a pole (16) of the switch (8). The positive wire (15) from the power source connector (13) connects to one pole (18) of the tone generator (11). The negative wire (14) joins the second pole (17) of the switch (8) to the second pole (19) of the auditory tone generator (11).

### OPERATION OF INVENTION

The enclosure (20) protects and supports the attachment site (4), the tone generator (11), power source (12), and the power source connector (13). The attachment site (4) is used to secure a tether, supplied by the user, made of cord, string, wire, chain or other flexible or rigid material. The power connector (13) is attached to the power supply (12). The connector (13) transfers the electrical power to the switch (8). The switch (8) in the open position renders the circuit and demonstration inoperable. The switch (8) in the closed position transmits electrical power to the tone generator (11) and back to the power supply (12). The tone generator (11) produces a constant frequency sound when power is supplied.

### CONCLUSION, RAMIFICATIONS, AND SCOPE OF THE INVENTION

From the description above, the reader can determine the advantages of the self-contained Doppler demonstrator. This demonstrator requires no assembly or disassembly for operation. The use of a switch makes use of the demonstrator easy and instantaneous. The instructor can communicate with students and observers during use. The enclosure protects the components from loss, damage, and vandalism. In case of damage or malfunction, all parts are readily available, inexpensive, and easy to replace.

While my description above describes a specific preferred embodiment of the demonstrator, the preferred embodiment should be viewed as an example of the many possible embodiments. Many variations are possible. The demonstrator enclosure and components can be of any shape, size, color, and material. The method of securing the two halves of the enclosure case of a circular enclosure, or any other means. The demonstrator components can be mounted in the enclosure in a variety of locations. The tether attachment site can be molded into the enclosure or be replaced with a hole in the enclosure with the tether fixed to an internal support. The switch could be a toggle form, magnetic reed style, or any other means for completing and breaking the circuit. A multi-position switch could be used to select two or more different frequency auditory tone generators. The switch can be installed at any position within the circuit. The electrical power supply can be of any convenient size.

The scope of the self-contained Doppler demonstrator should be determined not by the embodiment illustrated, but by the appended claims and their legal equivalents.

### SUMMARY

The self-contained Doppler demonstration provides educators with a safer and easier to use means for demonstrating the Doppler effect than any system currently available. Because of the enclosure, the demonstrator resists tampering and requires no set-up time. Because of the switch, the demonstrator is easy to use and control which enhances the educator's use of time in the lesson. Because of the low cost of components, the demonstrator is amazingly less expensive than the ones described in the appendix.

I claim:

1) A self-contained Doppler effect demonstration device comprising:
(a) a device for producing and controlling a continuous constant-frequency audible tone consisting of several inter-related components;
(i) a self-contained power source,
(ii) an electrical power connector,
(iii) a switch,
(iv) an auditory tone generator,
(v) a means of connecting and relating said components in an electrical circuit,
(b) an enclosure providing a means for protecting and supporting said components,
(c) a point of attachment for a tether providing a means for rotary motion, whereby the device when producing a constant auditory tone while in rotary motion is a means for demonstrating the Doppler effect in a controlled manner.
